(19) United States
(12) Patent Application Publication
(10) Pub. No.: US 2017/0280207 A1
(43) Pub. Date: Sep. 28, 2017

(54) VIDEO STREAM REDIRECTING METHOD, DEVICE, AND AN ELECTRONIC APPARATUS

(71) Applicant: WANGSU SCIENCE & TECHNOLOGY CO., LTD., Shanghai (CN)

(72) Inventor: Xin WU, Shanghai (CN)

(21) Appl. No.: 15/508,658

(22) PCT Filed: Nov. 11, 2015
(86) PCT No.: PCT/CN2015/094270

§ 371 Date: Mar. 3, 2017

(30) Foreign Application Priority Data
Jun. 26, 2015 (CN) 2015103597945

(51) Int. Cl. H04N 21/858; H04L 29/06

(52) U.S. Cl. CPC H04N 21/858; H04L 65/60

(57) ABSTRACT

A video stream redirecting method, device, and an electronic apparatus according to the present disclosure hijacks an original initialization function by constructing a new initialization function for video URL and exchanging, addresses of the original function and the new initialization function for video URL. That is, when a system calls the original initialization function to request a corresponding video, the new initialization function for video URL is executed to redirect the video stream to a designated proxy server, and thus realizing the stream redirecting of video requests for the UIWebView widget in iOS.

### TECHNICAL FIELD

The present disclosure relates to the technical field of communications and, more particularly, relates to a video stream redirecting method, device, and an electronic apparatus.

### BACKGROUND TECHNOLOGIES

In existing methods, redirecting a stream to a designated proxy server is usually realized through the process steps shown in FIG. 1. Assume an image is requested, the corresponding URL of the image is http://hostnameA.com/icon.jpg, and the stream of the request for the image needs to be redirected to the designated proxy server, which, for example, has an IP address of 127.0.2.1, then the method for redirecting the stream includes: constructing the URL; initializing a corresponding function using the URL; initiating the request for the image; determining whether a proxy is set in the system; if yes, directly connecting to the designated proxy server and receiving image data returned by the designated proxy server; and if no, directly connecting to the server having a host name hostnameA and receiving the image data returned by the server having the host name hostnameA.

However, in a video requesting process in the UIWebView widget, the step of determining whether a proxy is set in the system cannot be performed. That is, the stream cannot be redirected according to the above-described stream redirecting method. Accordingly, existing stream redirecting methods are not suitable for redirecting video stream UIWebView,

### SUMMARY

In view of the alcove defects in the existing technologies, the present disclosure provides a video stream redirecting method, device, and an electronic apparatus, to solve the problems in the existing technologies which are not able to redirect the stream generated during video playback in UIWebView.

To achieve the above and other related objects, the present disclosure provides a video stream redirecting method, which includes: constructing a new initialization function for video URL, parameters and a return value of which are the same as those of an original initialization function; hijacking the original initialization function, such that when a system calls the original initialization function to request a corresponding video, the new initialization function for video URL is executed, changing a target address in the URL to an address of a designated proxy server so as to redirect the video stream to the designated proxy server.

Optionally, hijacking the original initialization function includes: exchanging actual, code addresses of the new initialization function for video URL and the original initialization function, such that when the system calls the original initialization function to request the corresponding video, the new initialization function for video URL is executed.

Optionally, the new initialization function for video URL is an AVUrlAsset class initialization method.

Optionally, executing the new initialization function for video URL to redirect the video stream to the designated proxy server includes: determining whether a host name of the URL parameter in the original initialization function is the same as a host name of the designated proxy server; if so, directly calling back the original initialization function to request the corresponding video, to redirect the video stream to the designated proxy server; and if not, changing the host name of the URL parameter to the host name of the designated proxy server, extracting the host name and a path of the URL parameter before being changed as a path of the URL parameter after being changed, and then calling back the original initialization function to request the corresponding video, to redirect the video stream to the designated proxy server.

Optionally, before determining whether the host name of the URL parameter in the original initialization function is the same as the host name of the designated proxy server, it is determined whether the accessing mode of the URL parameter in the original initialization function is http or https; if not, the original initialization function is called back directly to request the corresponding video; and if so, determining whether the host name of the URLfunction in the original initialization function is the same as the host name of the designated proxy server is performed.

To achieve the above and other related objects, the present disclosure also provides a video stream redirecting device, including: a function construction module, configured to construct a new initialization function for video URL, parameters and a returned value of which are the same as those of an original initialization function; a stream redirecting module, configured to hijack the original initialization function, such that when a system calls the original initialization function to request a corresponding video, the new initialization function for video URL is executed, changing a target address in the URL to an address of a designated proxy server so as to redirect the video stream to the designated proxy server.

Optionally, hijacking the original initialization function by the stream redirecting module includes exchanging actual code addresses of the new initialization function for video URL and the original initialization function, such that when the system calls the original initialization function to request the corresponding video, the new initialization function for video URL is executed.

Optionally, the new initialization function for video URL is an AVUrlAsset initialization method.

Optionally, executing the new initialization function for video URL by the stream redirecting module to redirect the video stream to the designated proxy server includes: determining whether a host name of a URL parameter in the original initialization function is the same as a host name of the designated proxy server; if so, directly calling back the original initialization function to request the corresponding video; and if not, changing the host name of the URL parameter to the host name of the designated proxy server, extracting the host name and a path of the URL parameter before being changed as a path of the URL parameter after being changed, and then calling back the original initialization function to request the corresponding video, to redirect the video stream to the designated proxy server.

Optionally, the stream redirecting module is further configured to, before determining whether the host name of the URL parameter in the original initialization function is the same as the host name of the designated proxy server, determine whether an accessing mode of the URL parameter in the original initialization function is http or https; if not, then directly call back the original initialization function to request the corresponding video; and if so, then perform determining whether the host name of the URL parameter in the original initialization function is the same as the host name of the designated proxy server.

To achieve the above or other related objects, the present disclosure also provides an electronic apparatus. A system of the electronic apparatus is the iOS system. The electronic apparatus includes a video stream redirecting device according to any one of the above, to perform stream redirecting on a received video request.

Optionally, the electronic apparatus is a smart phone or a tablet.

As described above, a video stream redirecting method, device, and an electronic apparatus according to the present disclosure hijacks an original initialization function by constructing a new initialization function for video URL and exchanging addresses of the original initialization function and the new initialization function for video URL. That is, when the system calls the original initialization function to request a corresponding video, the new initialization function for video URL is executed to redirect the video stream to a designated proxy server, and thus realizing the stream redirecting of video requests for the UIWebView widget in iOS.

### BRIEF DESCRIPTION OF THE FIGURES

FIG. 1 shows a process flow diagram of an example of stream redirecting according to existing technologies.

FIG. 2 shows a process flow diagram of a video stream redirecting method according to an embodiment of the present disclosure.

FIG. 3 shows a process flow diagram of a video stream redirecting method according to another embodiment of the present disclosure.

FIG. 4 shows a block diagram of a video stream redirecting device according to an embodiment of the present disclosure.

FIG. 5 shows a schematic application diagram of an electronic apparatus and a server according to an embodiment of the present disclosure.

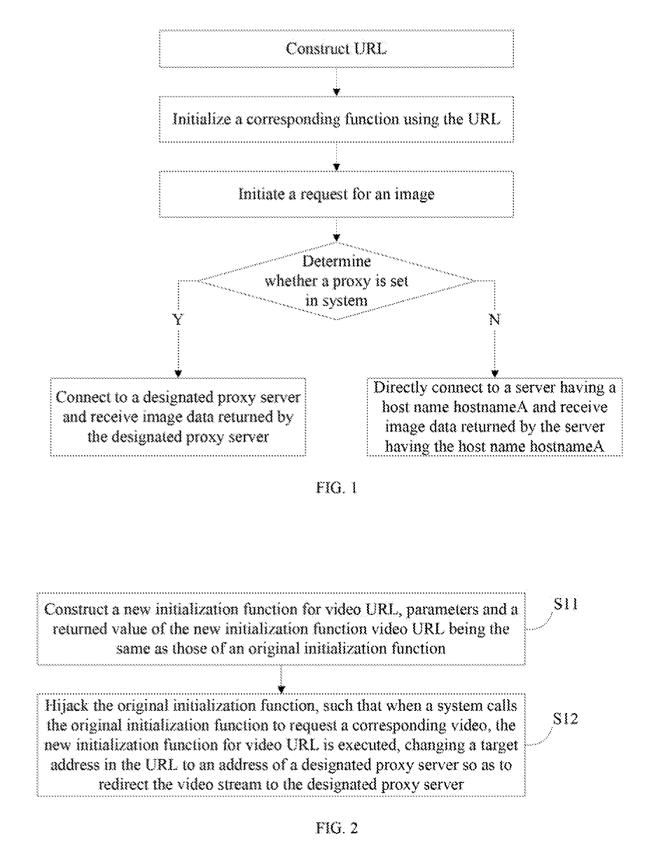

### EXPLANATION OF REFERENCE NUMERALS

1, 21 Video stream redirecting device
11 Function construction module
12 Stream redirecting module
2 Electronic apparatus
3 Server
S11-S12, S21-S26 Processes

### DETAILED DESCRIPTION OF EMBODIMENTS

Modes of implementing the disclosure will be described below through specific embodiments. One of ordinary skill in the art can easily understand other advantages and effects of the present disclosure based on the disclosure of the present specification. The present disclosure can also be implemented or applied through other different modes. Details in the present specification can also be modified or changed based on different views and applications, without departing the spirit of the present disclosure. It is to be noted that the following embodiments and the features in the embodiments can be combined as long as they do not conflict with each other.

It is to be noted that the drawings provided in the following embodiments merely schematically illustrate basic concept of the present disclosure. Each drawing only shows components relevant to the present disclosure, but does not show the number, shapes, and sizes of the components during actual implementation. During the actual implementation, the configuration, number, and dimensions of respective components can be Changed as needed, and the arrangement of the components may be more complicated.

FIG. 2 shows a process flow of video stream redirecting method according to an embodiment of the present disclosure. The method can be implemented, for example, in the UIWebView widget of the iOS system, and includes:

S11: constructing a new initialization function for video URL. Parameters and a returned value of the new initialization function for video URL are the saint as those of an original initialization function.

For example, a new initialization method, hookInitWithURL, can be constructed in a newly-defined AVUrlAsset class. The parameters and returned value of this method are kept the same as those of the original initialization method, InitWithURL, in the AVUrlAsset class.

S12: hijacking the original initialization function, such that when a system calls the original initialization function to request a corresponding video, the new initialization function for video URL is executed, changing a target address in the URL to an address of a designated proxy server so as to redirect the video stream to the designated proxy server. That is, before playing the video link using the UIWebView widget, the iOS system calls InitWithUrl in the AVUrlAsset class to perform initialization, at which time the constructed new method, hookInitWithURL, will be called but the original initialization method will not be called. As such, the video stream can be redirected to the designated proxy server.

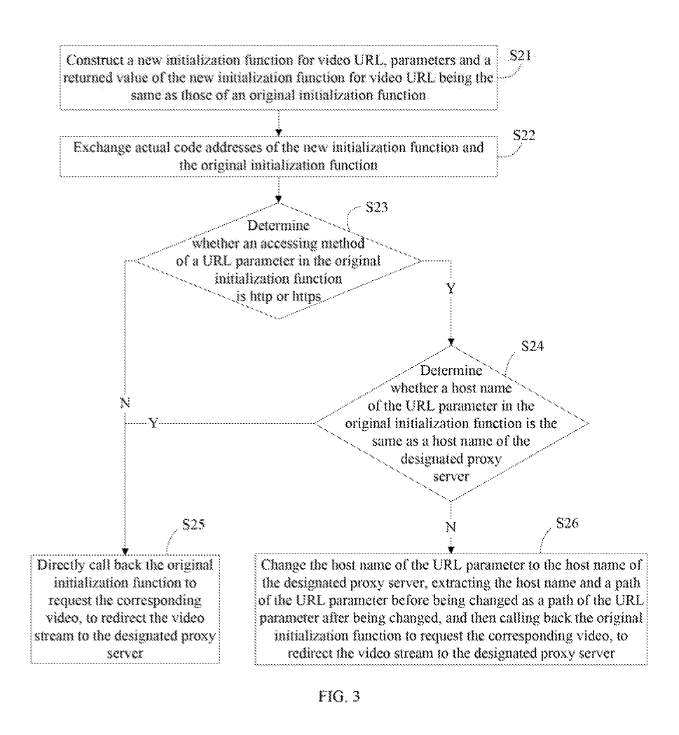

Further, FIG. 3 shows a process flow of a video stream redirecting method in UIWebView according to another embodiment of the present disclosure. The method includes:

S21: constructing a new initialization function for video URL. Parameters and a returned value of the new initialization function for video URL are the same as those of an original initialization function. The process in S21 is the same as the process in S11 in the embodiment shown in FIG. 2.

Further, the step of hijacking the original initialization function in S12 in the embodiment shown in FIG. 2 may include:

S22: exchanging actual code addresses of the new initialization function for video URL and the original initialization function, such that when the system calls the original initialization function to request the corresponding video, the new initialization function for video URL is executed. That is, actual code addresses of the newly-constructed initialization function and the original initialization function are obtained, respectively. After the exchanging, realization of InitWithURL will be executed when hookInitWithURL is called, while realization of hookInitWithURL will be executed when InitWithURL is called.

Further, in S12 in the embodiment shown in FIG. 2, executing the new initialization function for video URL when the system calls the original initialization function to request the corresponding video so as to redirect the video stream to the designated proxy server specifically includes:

S23: determining whether an accessing mode of a URL parameter in the original initialization function is http or https. If so, S24 is executed. If not, S25 is executed. That is, in this embodiment, the video stream redirecting may be performed only on accesses having an http or https accessing mode.

S24: determining whether a host name of the URL parameter in the original initialization function is the same as a host name of the designated proxy server. If so, S25 is executed. If not, S26 is executed.

S25: directly calling back the original initialization function to request the corresponding video, to redirect the video stream to the designated proxy server.

S26: changing the host name of the URL parameter to the host name of the designated proxy server, extracting the host name and a path of the URL parameter before being changed as a path of the URL parameter after being changed, and then calling back the original initialization function to request the corresponding video, to redirect the video stream to the designated proxy server.

Further, before determining whether the host name of the URL parameter in the original initialization function is the same as the host name of the designated proxy server, it is determined whether the accessing mode of the URL parameter in the original initialization function is http or https. If not, the original initialization function is called back directly to request the corresponding video. If so, determining whether the host name of the URL function in the original initialization function is the same as the host name of the designated proxy server is performed.

For example, in a specific application, assume the URL of a video request is: http://hostnameA.com/video, and the address of the designated proxy server is: 127.0.0.1:8123, then when the iOS system initializes an AVUrlAsset object, the newly-constructed initialization function is executed by hijacking the original initialization function. That is, the following is performed:

Because the accessing mode of the URL is http, it is further determined whether the host name of the URL parameter is the same as the host name of the designated proxy server.

In this application example, the host name of the URL parameter is different from the host name of the designated proxy server. Thus, the host name of the URL is changed to 127.0.0.1:8123, and the path is changed to hostnameA.com/video. The new URL, http://127.0.0.1:8123/hostnameA.com/video, is formed. The original initialization function is then called back using the changed URL as a parameter to request the corresponding video, to redirect the video stream to the designated proxy server 127.0.0.1:8123.

The present disclosure is explained with respect to the video stream in the iOS system. One of ordinary skill in the art should understand that, based on similar inventive concept, adaptive parameter modifications can be performed on another system such as the android system, and the purpose of redirecting videos can also be achieved. It should also fall in the scope of protection of the present disclosure.

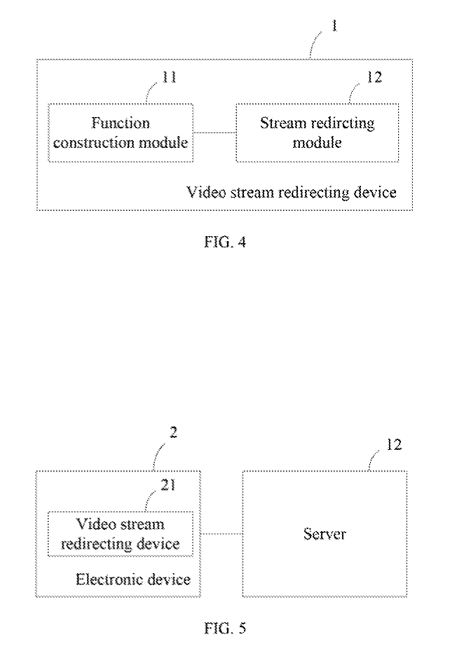

FIG. 4 shows a block diagram of a video stream redirecting device according to an embodiment of the present disclosure. The video stream redirecting device can be implemented, for example, in an electronic apparatus having the iOS system. The video stream redirecting device 1 includes a function construction module 11 and a stream redirecting module 12.

The function construction module 11 is configured to construct a new initialization function for video URL. Parameters and a returned value of the new initialization function for video URL are the same as those of an original initialization function.

The stream redirecting module 12 is configured to hijack the original initialization function, such that when a system calls the original initialization function to request a corresponding video, the new initialization function for video URL is executed, changing a target address in the URL to an address of a designated proxy server so as to redirect the video stream to the designated proxy server.

Further, in another embodiment, hijacking the original initialization function by the stream redirecting module 12 includes exchanging actual code addresses of the new initialization function for video URL and the original initialization function, such that when the system calls the original initialization function to request the corresponding video, the new initialization function for video URL is executed.

Further, in another embodiment, executing the new initialization function for video URL by the stream redirecting module 12 to redirect the video stream to the designated proxy server includes: determining whether a host name of a URL parameter in the original initialization function is the same as a host name of the designated proxy server; if so, directly calling back the original initialization function to request the corresponding video; and if not, changing the host name of the URL parameter to the host name of the designated proxy server, extracting the host name and a path of the URL parameter before being changed as a path of the URL parameter after being changed, and then calling back the original function to request the corresponding video, to redirect the video stream to the designated proxy server.

Further, in another embodiment, the stream redirecting module 12 is further configured to, before determining whether the host name of the URL parameter in the original initialization function is the same as the host, name of the designated proxy server, determine whether an accessing mode of the URL parameter in the original initialization function is http or https; if not, then directly call back the original initialization function to request the corresponding video; and if so, then perform determining whether the host name of the URL parameter in the original initialization function is the same as the host name of the designated proxy server.

The application principle and the technical features of the video stream redirecting device 1 correspond to the video stream redirecting methods shown in FIG. 2 and FIG. 3, and thus detailed description of examples thereof is not repeated here.

FIG. 5 shows a schematic application diagram of an electronic apparatus and aserver according to an embodiment of the present disclosure. A system of the electronic apparatus 2 may be, for example, the iOS system. The electronic apparatus includes a video stream redirecting device 21 to redirect a received video request stream to the server 3. When receiving the video request sent by the electronic apparatus 2, the server 3 returns a corresponding video to the electronic apparatus 2. The structure and application principle of the video stream redirecting device 21 are the same as those of the video stream redirecting device 1 shown in FIG. 4. In some embodiments, the electronic apparatus is a smart phone or a tablet.

In summary, a video stream redirecting method, device, and an electronic apparatus according to the present disclosure hijacks an original initialization function by constructing a new initialization function for video URL and exchanging addresses of the original initialization function and the new initialization function for video URL. That is, when the system calls the original initialization function to request a corresponding video, the new initialization function for video URL is executed to redirect the video stream to a designated proxy server, and thus realizing the stream redirecting of video requests for the UIWebView widget in iOS. Therefore, the present disclosure overcomes various defects in the existing technologies, and thus has a high value in industrial applications.

The above-described embodiments are merely examples for explaining the principles and effects of the present disclosure, but not to limit the present disclosure. Any person familiar with the technology can modify or change the above-described embodiments without departing from the spirit and scope of the present disclosure. Therefore, any equivalent modification and change accomplished by a person of ordinary skill in the art without departing the spirit and technical idea disclosed by the present disclosure should be covered by the claims set forth below.

1. A video stream redirecting method, comprising:
constructing a new initialization function for video URL, parameters and a returned value of the new initialization function for video URL being the same as parameters and a returned value of an original initialization function; and
hijacking the original initialization function, such that when a system calls the original initialization function to request a corresponding video, the new initialization function for video URL is executed, changing a target address in a URL to an address of a designated proxy server, to redirect a video stream to the designated proxy server.

2. The video stream redirecting method according to claim 1, wherein hijacking the original initialization function includes:
exchanging actual code addresses of the new initialization function for video URL and the original initialization function, such that when the system calls the original initialization function to request the corresponding video, the new initialization function for video URL is executed.

3. The video stream redirecting method according to claim 1, wherein the new initialization function for video URL includes an AVUrlAsset class initialization function.

4. The video stream redirecting method according to claim 1, wherein executing the new initialization function for video URL to redirect the video stream to the designated proxy server includes:
determining whether a host name of a URL parameter in the original initialization function is the same as a host name of the designated proxy server;
if so, directly calling back the original initialization function to request the corresponding video, to redirect the video stream to the designated proxy server; and
if not, changing the host name of the URL parameter to the host name of the designated proxy server, extracting the host name and a path of the URL parameter before being changed as a path of the parameter after being changed, and then calling back the original initialization function to request the corresponding video, to redirect the video stream to the designated proxy server.

5. The video stream redirecting method according to claim 4, further comprising, before determining whether the host name of the URL parameter in the original initialization function is the same as the host name of the designated proxy server:
determining whether an accessing mode of the URL parameter in the original initialization function is http or https;
if not, directly calling back the original initialization function to request the corresponding video; and
if so, determining whether the host name of the URL function in the original initialization function is the same as the host name of the designated proxy server.

6. A video stream redirecting device, comprising:
a function construction module, configured to construct a new in function for video URL, parameters and a returned value of the new initialization function for video URL being the same as parameters and a returned value of an original initialization function;
a stream redirecting module configured to hijack the original initialization function, such that when a system calls the original initialization function to request a corresponding video, the new initialization function for video URL is executed, changing a target address in a URL to an address of a designated proxy server so as to redirect the video stream to the designated proxy server.

7. The video stream redirecting device according to claim 6, wherein the stream redirecting module being configured to hijack the original initialization function includes:
being configured to exchange actual code addresses of the new initialization function for video URL and the original initialization function, such that when the system calls the original initialization function to request a corresponding video, the new initialization function for video URL is executed.

8. The video stream redirecting device according to claim 6, wherein the new initialization function for video URL includes an AVUrlAsset class initialization function.

9. The video stream redirecting device according to claim 6, wherein executing the new initialization function for video URL by the stream redirecting module to redirect the video stream to the designated proxy server includes;
determining whether a host name of a URL parameter in the original initialization function is the same as a host name of the designated proxy server;
if so, directly calling back the original initialization function to request the corresponding video; and
if not, changing the host name of the URL parameter to the host name of the designated proxy server, extracting the host name and a path of the URL parameter before being changed as a path of the URL parameter after being changed, and then calling back the original initialization function to request the corresponding video, to redirect the video stream to the designated proxy server.

10. The video stream redirecting device according to claim 9, wherein the stream redirecting module is further configured to, before determining whether the host name of the URL parameter in the original initialization function is the same as the host name of the designated proxy server:
determine whether an accessing mode of the URL parameter in the original initialization function is http or https;
if not, then directly call back the original initialization function to request the corresponding video; and
if so, then determine whether the host name of the URL parameter in the original initialization function is the same as the host name of the designated proxy server.

11. An electronic apparatus, wherein a system of the electronic apparatus is an iOS system, and the electronic apparatus includes the video stream redirecting device according to claim 6, to perform stream redirecting on a received video request.

12. The video stream redirecting method according to claim 2, wherein the new function for video URL includes an AVUrlAsset class initialization function.

13. The video stream redirecting method according to claim 1 wherein the original initialization function includes an InitWithURL function and the new initialization function for video URL includes a hookInitWithURL function having the same parameters and returned value as the InitWithURL function.

14. The video stream redirecting method according to claim 1, wherein the system is an iOS system.

15. The video stream redirecting device according to claim 7, wherein the new initialization function video URL includes AVUrlAsset class initialization function.

16. The video stream redirecting device according to claim 6, wherein the original initialization function includes an InitWithURL function and the new initialization function for video URL includes a hookInitWithURL function having the same parameters and returned value as the InitWithURL function.

17. An electronic apparatus, wherein a system of the electronic apparatus is an iOS system, and the electronic apparatus includes the video stream redirecting device according to claim 7, to perform stream redirecting on a received video request.

18. An electronic apparatus, wherein a system of the electronic apparatus is an iOS system, and the electronic apparatus includes the video stream redirecting device according to claim 8, to perform stream redirecting on a received video request.

19. An electronic apparatus, wherein a system of the electronic apparatus is an iOS system, and the electronic apparatus includes the video stream redirecting device according to claim 9, to perform stream redirecting on a received video request.

20. An electronic apparatus, wherein a system of the electronic apparatus is an iOS system, and the electronic apparatus includes the video stream redirecting device according to claim 10, to perform stream redirecting on a received video request.
